(19) United States
(12) Patent Application Publication
(10) Pub. No.: US 2021/0056654 A1
(43) Pub. Date: Feb. 25, 2021

(54) MAKING A WORK ENVIRONMENT SAFE USING AT LEAST ONE ELECTRONIC BEACON AND AN ELECTRONIC TAG

(71) Applicants: XP DIGIT, Villeneuve d'Ascq (FR); ENEDIS, Paris (FR)

(72) Inventors: Benoit BELLAVOINE, Forest-sur-Marque (FR); Mathieu CARON, Betton (FR); Sebastien DO, Lille (FR); Pierre DZIWNIEL, Chereng (FR)

(21) Appl. No.: 16/958,456

(22) PCT Filed: Dec. 26, 2018
(86) PCT No.: PCT/FR2018/053550

§ 371 Date: Jun. 26, 2020

(30) Foreign Application Priority Data
Dec. 28, 2017 (FR) 1763293

(51) Int. Cl. G06Q 50/26; H04L 29/08; H04L 12/24; G06Q 10/06; G06Q 10/10; G06Q 10/00; G01S 1/68

(52) U.S. Cl. CPC G06Q 50/265; H04L 67/18; H04L 41/0806; G01S 1/68; G06Q 10/109; G06Q 10/20; G06Q 10/105; G06Q 10/0635

(57) ABSTRACT

The present invention relates to a method and apparatus for making a work safe using at least one electronic beacon and an electronic tag carried by an operator. The beacon and the tag are capable of communicating with one another using a communication scheduler implementing a communication management algorithm. The work environment includes at least one exclusion zone for the operator.

### TECHNICAL FIELD AND PRIOR ART

The present invention relates to the field of safety.

The present invention more particularly relates to making a work environment safe, for example a work environment of the worksite type comprising at least one work zone and at least one exclusion zone such as, for example, a danger zone.

One of the purposes of the present invention consists of proposing a so-called “micro-location” solution allowing for the very precise location of staff operating in a work environment so as to make this environment safe.

The present invention has numerous advantageous applications in the field of industrial worksites such as, for example, worksites involving electrical works on transformer substations and/or on electrical installations with high voltages or high currents.

The present invention has other advantageous applications in other fields such as, for example, making roadworks safe, such as road renovation works, making building works safe, making safe works carried out on a wide range of industrial sites (in the chemical industry, petrochemical industry, production industry, waste processing industry, logistics industry, motor industry, aeronautical industry, or iron and steel industry, etc.) or even making safe works carried out in nuclear power stations.

Further applications can also be considered in other fields such as:
for example, damage prevention on an archaeological excavation site, for which the exclusion zone can correspond to an excavation zone likely to contain fossils or other fragile remains (whereby this zone must be entered with caution so as not to deteriorate the site);
for example making safe military operations for which the exclusion zone can correspond to a hazardous zone (potentially containing land mines or contamination for example);
for example making farmlands or farming zones safe (such as agricultural silos for example) for which the exclusion zone can correspond to a space presenting a falling hazard or for which the exclusion zone can correspond to farm machinery. Said exclusion zone can thus be moving (travelling machinery) relative to the work zone;
for example, making safe sites or zones within the scope of the search for victims of accidents or natural disasters for which the exclusion zone can correspond to unsafe zones, access whereto is restricted to rescue services or to government structures responsible for securing the zone;
for example, delimiting “prohibited” zones within the scope of leisure or recreational activities, for which the exclusion zone would be included in the implementation of a virtual labyrinth or a virtual role play game.

The term work environment used herein must be understood in the present description to mean an environment in which one or more human interventions (for example: works, maintenance tasks, renovations, excavations, etc.) are planned.

The term exclusion zone used herein must be understood in the present description to mean a zone (or optionally an object that forms a part of the work environment) in which (or with which) an operator is likely to encounter a hazard such as, for example, an electrocution hazard, an injury hazard or even a radiation or other hazard.

Preferably, all or part of the intervening staff must be informed when a person enters (or approaches) such a zone (or such an object), in particular for safety reasons and/or authorisation or accreditation reasons.

It should be noted here that an exclusion zone can be stationary or moving (for example if referring to a hazardous object capable of moving in the environment).

Within the scope of emergency interventions or maintenance tasks, hazard signalling, intended to limit accidents during interventions on the site, is usually carried out manually by means of physical marking and/or signage.

Thus, the marking of hazardous zones using physical markers such as cones, nets, barriers, chains, poles or even barrier tape is known.

This physical marking is often complemented by signage of the danger sign type or equivalent, or even by paper or digital manuals and protocols provided to operators in advance or during the interventions.

This marking and/or signage is often complemented by a colour coding scheme where:
red or orange colours are used to indicate the presence of a hazard, and
blue or green colours are used to indicate safety (or no hazards).

This marking and/or signage for making safe a work environment (for example a worksite) and delimiting exclusion zones (for example danger zones) is simple and fast to install.

However, the Applicants have observed that the use of physical markers and signage has numerous drawbacks.

Physical markers and associated signage are passive: they do not interact with the people working in the work environment.

For the purposes of illustration, a person who steps over a marker or who enters a danger zone that is not properly marked out is not warned of the risk he or she is taking.

Moreover, when a person voluntarily enters a danger zone, no manager or other colleague is warned of this intrusion and of the risk taken by this person.

The use of physical markers and signage can also lead to an increased risk of confusion.

More specifically, the Applicants have observed that the human factor plays a key role in a large proportion of the accidents that occur on a worksite or when carrying out a maintenance task.

Despite the presence of appropriate marking and signage, the risk of confusion thus remains present. An operator can unintentionally disregard the marker and be in danger, in particular in an emergency situation where it is natural for the former to lower their guard when acting in haste.

Physical markers and signage are also subject to degradation over time. This degradation, often of climatic and/or human origin, is silent.

By way of example, no warning is transmitted if the wind affects the integrity of the marking or if an operator knocks over or degrades (intentionally or otherwise) a marking or signage element.

As a result, the delimitation of the exclusion zones can be easily degraded over time; only routine visual inspection and/or verification by a conscientious, cognizant individual allows degradation to be detected and corrected where necessary.

Finally, the Applicants have observed that physical markers and signage are bulky and require local storage or transportation for installation on the worksite.

Provision of the right marking or signage elements, the fast installation thereof, or the movement thereof in the event of a moving worksite are not always a trivial matter.

Emerging techniques now exist to overcome the various aforementioned drawbacks.

These techniques are mainly based on the use of connected objects for locating operators in a defined and modelled space, and require 2D or 3D modelling of the work space.

Once the work space has been modelled, and according to the current techniques for locating operators in real time relative to virtual danger zones, it is provided that: each operator is equipped with a receiver which communicates with fixed anchors of the electronic beacon type, which themselves communicate with a gateway capable of determining the position of each of the operators relative to the different virtual danger zones configured in advance (in 2D or 3D).

These solutions implement various technologies for obtaining a sufficiently high degree of precision and reactivity; the most commonly used technology is UWB (Ultra Wide-Band) technology and the location techniques involve trilateration and UWB signal propagation delay in air.

The hardware infrastructure required for the techniques currently implemented is thus heavy and restrictive in terms of installation.

The location of moving operators carrying receivers of the electronic tag type requires the installation of fixed UWB beacons.

Moreover, these beacons often require a power supply and the ability to communicate with a gateway over a dedicated network: a wired network (for example Ethernet) or a wireless network (for example Wi-Fi).

Such a gateway takes the form of a server capable of communicating with all of the beacons and equipped with a high computing power.

The implementation of the network dedicated to communications between the gateway and the beacons imposes numerous restrictions in terms of installation, configuration and power supply.

One example embodiment of such a known installation in the prior art is shown in FIG. 1.

This FIG. 1 shows a work environment ZT with an exclusion zone ZD. The operator responsible for safety in the work environment ZT previously positions the beacons B and the gateway G while meeting all restrictions associated with such a configuration, i.e. mainly the restrictions regarding the power supply for each beacon B and the gateway G, as well as the restrictions regarding installing the beacons B, i.e. adjusting the height of each beacon B and testing the range of the signal from each beacon B.

In this configuration, each beacon B must be able to communicate directly with the gateway G. The implementation of such a gateway G thus imposes several restrictions, in particular including the power supply, network connectivity and a specific location in the work environment ZT allowing it to communicate with each beacon B over the dedicated network.

This requires an inspection of the site, a configuration and numerous tests before being able to make the environment safe.

Such an installation with a gateway thus requires a specific configuration as a function of the layout of the premises, which in particular requires previously inspecting the site, producing drawings, taking measurements, modelling the work environment, testing and calibration, etc.

All these steps considerably increase the implementation times and are incompatible with short interventions or with moving worksites or with outdoor use (network restrictions, weather restrictions, etc.).

Furthermore, the Applicants consider this solution to be ill-suited for outdoor use or for use in an environment with significant safety restrictions.

Such solutions can be very difficult to install outdoors: impossible to install the beacons high up, impossible to procure a power supply, impossible to access certain spaces within the worksite or intervention zones as a result of the hazards present when installing the beacons, no dedicated network, etc.

The precise location of people using emerging techniques thus requires a specific configuration of the environment: the location techniques deployed to date propose a volumetric approach which is equivalent to building a frame of reference in which the danger zones are defined relative to which the operators are located. These techniques in particular require a power supply, a specific configuration (beacons within signal range, beacons placed high up, etc.), previous modelling (which takes time), the use of a gateway, and good connectivity.

For at least these reasons, the Applicants consider that there is no solution thus far that allows a work environment to be made safe in a quick and simple manner by delimiting exclusion zones for warning operators working in the environment in a reliable and effective manner

### Purpose and Summary of the Present Invention

The present invention aims to improve on the situation described hereinabove.

One of the purposes of the present invention is to overcome the various aforementioned drawbacks by proposing an innovative solution for making a work environment safe using at least one electronic beacon and an electronic tag carried by an operator.

The subject matter of the present invention relates, according to a first aspect, to a method for making a work environment safe using at least one electronic beacon and an electronic tag carried by an operator.

Preferably, the electronic tag is compact and electrically autonomous by being battery-operated (or alternatively electrically connected to a communication terminal acting as a power source).

According to the invention, the at least one beacon and the tag are capable of communicating with one another according to a communication scheduler implementing a communication management algorithm.

Such a scheduler is preferably integrated into each beacon and each tag and prevents the need to use a “master” device such as a gateway as proposed in the emerging techniques described in the preamble and proposing a volumetric approach to location operations.

Advantageously, the work environment comprises at least one exclusion zone for the operator.

According to the invention, the method is implemented by computer-based means and the communication scheduler and includes:
a) an initial configuration phase, and
b) a use phase.

Advantageously, the configuration phase comprises the following steps:
beaconing, during which the at least one electronic beacon is positioned in the work environment so as to delimit the exclusion zone; and
modelling the exclusion zone by generating a virtual safety cordon according to the positioning of the at least one beacon in the work environment.

Advantageously, the use phase comprises the following steps:
measuring the distance of the electronic tag relative to the at least one beacon;
determining the relative position of the operator in the work environment according to the measured distance; and
generating, by the tag, a warning signal for the operator when said operator crosses the virtual safety cordon.

Thus, unlike with the emerging techniques implemented to date, the present invention is based on the logic of a virtual safety cordon and not on locating operators at all points in the work environment.

The approach proposed within the scope of the present invention is a perimetric approach aiming to model the exclusion zone using a virtual safety cordon.

This virtual safety cordon logic defined in the digital model of the work environment by the position of the beacons allows the exclusion zones to be materialised with minimal computation time and any approaches or entries into these zones to be detected so as to issue alerts to the operators concerned.

This perimetric approach, coupled with the implementation of a scheduler preventing the need to use a “master” device such as a gateway, is focused on locating the one or more operators in the vicinity of the one or more exclusion zones only (in this case, the most relevant zones as regards the issue of safety) and not on the position of the operators at all points in the work environment (volumetric approach).

The use of beacons to delimit the exclusion zones further reduces the installation costs by procuring a solution that is quick to install of the “plug & play” type.

Moreover, such a solution is portable since it is quasi autonomous in terms of power and is adapted to moving worksites.

Finally, such a solution can be considered to be a multi-environment solution since it is equally suited to outdoor and indoor uses with or without a network.

In one specific embodiment of the present invention, the beaconing step comprises positioning a single electronic beacon to delimit the exclusion zone. In this embodiment, during the modelling step, a virtual safety cordon is generated in the form of a virtual circle, the radius whereof corresponds to a determined safety distance around said beacon.

It is understood here that this safety radius is determined as a function of the nature of the exclusion such as, for example, the extent to which this zone is hazardous.

In another specific embodiment of the present invention, the beaconing step comprises positioning at least two beacons at the periphery of the at least one exclusion zone. In this embodiment, during the modelling step, a virtual safety cordon is generated in the form of a corridor comprising at least one segment defined by the at least two beacons. It is understood here that this corridor delimits the work space in which the operators can work and the exclusion zone in which the presence thereof is not desired, for example for safety reasons and/or for accreditation or authorisation reasons.

Advantageously, during the measuring step, the distance between the electronic tag and each beacon is measured.

Preferably, the at least one beacon and the tag are capable of communicating with one another according to a communication protocol of the UWB type configured so as to determine the distance between the tag and the at least one beacon.

Preferably, a comparison of these distances is provided so as to determine the shortest distances between the tag and each of the beacons.

Preferably, this protocol further allows information or instructions to circulate between the beacons and the tags.

Advantageously, during the modelling step, the distances between each of the beacons can be measured, then compared so as to determine segments of the corridor between the closest beacons.

This original approach is based on the logic of the aforementioned virtual safety cordon. Unlike current emerging techniques using a volumetric approach, the present invention does not seek to represent the entire work environment in 2D or 3D, but proposes a perimetric approach aiming to model the contours of the one or more exclusion zones. According to this perimetric approach, each pair of positioned beacons allows a corridor segment to be created.

A plurality of zones can thus be created, each with a plurality of segments.

Advantageously, said at least two beacons are capable of communicating with one another according to a communication protocol of the UWB type configured so as to determine the shortest distances between the beacons.

Preferably, each segment of the virtual safety corridor is defined by the successive beacons, in pairs, in the order in which they have been configured. In this case, these are, for example, the two beacons situated the closest to one another from among a plurality of beacons.

The use of such a protocol is thus advantageous in that it facilitates the determining of the distances between the beacons in order to model the one or more exclusion zones.

Advantageously, the relative position of the operator in the work environment is determined as a function of the distances from the tag to the closest segments of the exclusion zone.

More specifically, the position of each operator, carrying a tag, is not determined in absolute form throughout the entire worksite, but is only determined relative to the closest segments of the exclusion zones.

The algorithm implemented does not require trilateration; the solution proposed within the scope of the present invention is thus less restrictive in terms of the positioning of the beacons; more specifically, each beacon must only be able to communicate with the previous and next beacons of a corridor. This is sufficient for detecting, in a precise and reliable manner, the relative position of each operator in the environment and thus for detecting when the segments, and thus a safety corridor, is crossed.

Advantageously, the operator is provided with a communication terminal implementing software functions configured so as to receive the warning signal and inform the operator by way of an audible, vibratory and/or light signal.

It must be understood here that this is an optional embodiment and that the audible, vibratory and/or light signal can be triggered solely by the electronic tag.

Optionally, the operator is provided with a communication terminal implementing software functions configured so as to provide global position information (for example originating from a GPS) for the operator in the work environment and display the digital model of the work environment with the position of the operator as a function of the global position information and the relative position of the operator determined during the determination step.

The use of this global position information originating, for example, from a GPS accompanies the user when configuring the beacon, in particular so as to provide the user with a 2D representation on a map background of the segments of the danger zones.

Moreover, the GPS offers a redundant location system, even though it is less precise than the main system.

Finally, the GPS proposes additional services for operators: contextual information, digital signage, etc.

Advantageously, the electronic tag is provided with at least one additional sensor of the accelerometer type for example, capable of detecting a fall and/or potential accident for example when said operator crosses the virtual safety cordon and penetrates said exclusion zone.

The use of such a sensor allows falls, sudden movements or abnormal phases of immobility to be detected for an operator.

These detections based on additional sensors enter into the scope of making interventions safe by allowing alerts to be triggered in the case of an accident (whether or not linked to the crossing of a corridor).

Advantageously, the relative position of the operator in the work environment is determined according to a period determined dynamically as a function of the distance measured between the last position of said operator and the virtual safety cordon.

Preferably, the greater the distance measured between the last position of the operator and the virtual safety cordon, the longer the period for carrying out the next determination step. This dynamic management of the determination of the relative position of each operator relative to the one or more exclusion zones allows communications between the beacons and the tags to be considerably limited, which reduces the power consumed by each device and thus increases the autonomy thereof.

Advantageously, the generation of the warning signal is carried out as a function of the determined authorisation level associated with the operator carrying the electronic tag, the authorisation level being recorded in storage means of the tag.

It is thus understood that the alerts transmitted by the system can be managed by associating the notion of an authorisation level therewith. An authorised person can thus cross the safety cordon without any alert being transmitted.

Advantageously, each operator is provided with a tag and is warned by an audible, vibratory and/or light signal when entering an exclusion zone, in the case of a fall and/or in the case of a possible accident suffered by one of said operators.

Advantageously, the method according to the present invention comprises, during the use phase, continuous self-diagnostics so as to detect the displacement and/or failure of at least one beacon and alert at least one operator thereof.

Correlatively, according to a second aspect, the present invention relates to a computer program that comprises instructions suitable for executing the steps of the method as described hereinabove, in particular when said computer program is executed by at least one processor.

Such a computer program can use any programming language and be in the form of a source code, object code, or intermediate code between a source code and an object code, such as a partially compiled form, or in any other desired form.

Similarly, according to a third aspect, the present invention relates to a computer-readable recording medium on which a computer program (or embedded software) is stored, said computer program comprising instructions for executing the steps of the method as described hereinabove.

On the one hand, the recording medium can be any entity or device capable of storing the program. For example, the medium can comprise a storage means, such as a ROM, for example a CD-ROM or a microelectronic circuit-type ROM, or even a magnetic recording means or a hard drive.

On the other hand, this recording medium can also be a transmittable medium such as an electric or optical signal, such a signal capable of being carried via an electric or optical cable, by conventional or wireless radio, or by self-steered laser beam or any other means. The computer program according to the invention can in particular be downloaded from an Internet-type network.

Alternatively, the recording medium can be an integrated circuit into which the computer program is incorporated, the integrated circuit being suitable for executing or for use in the execution of the method in question.

According to a fourth aspect, the present invention relates to a computer system for making a work environment safe using at least one electronic beacon and an electronic tag carried by an operator, said beacon and said tag being capable of communicating with one another using a communication scheduler implementing a communication management algorithm.

According to the invention, the system comprises computer-based means designed to implement the steps of the method described hereinabove.

More particularly, the system includes:
at least one electronic beacon positioned in the work environment so as to delimit the exclusion zone; and
computer modelling means configured to digitally model the exclusion zone by generating a virtual safety cordon according to the positioning of the at least one beacon in the work environment,
measuring means configured to measure the distance from the electronic tag to the at least one beacon;
computer processing means configured to determine the relative position of the operator in the work environment according to the measured distance; and
generating means integrated into the tag, for generating a warning signal for the operator when the operator crosses the virtual safety cordon.

According to a fifth aspect, the present invention relates to a use of the method as described hereinabove for making safe a work environment of the worksite type, wherein the at least one exclusion zone is a danger zone for the operator.

Alternatively, according to a sixth aspect, the present invention relates to a use of the method as described hereinabove for making safe a work environment of the archaeological site type, wherein the at least one exclusion zone is an excavation zone likely to contain fossils or other fragile remains (this zone must be entered with caution so as not to deteriorate the site, and the archaeologists are informed of this entry).

Alternatively, according to a seventh aspect, the present invention relates to a use of the method as described hereinabove for making safe military operations, wherein the at least one exclusion zone corresponds to a hazardous zone (potentially containing land mines or contamination for example).

Alternatively, according to an eighth aspect, the present invention relates to a use of the method as described hereinabove for making safe farmland or farming zones (such as agricultural silos for example), wherein the at least one exclusion zone corresponds to a space presenting a falling hazard for example, or for which the exclusion zone corresponds to farm machinery. Said exclusion zone would thus be moving (travelling machinery) relative to the work zone.

Alternatively, according to a ninth aspect, the present invention relates to a use of the method as described hereinabove for making safe sites or zones within the scope of the search for victims of accidents or natural disasters, wherein the at least one exclusion zone is an unsafe zone, access whereto is restricted to rescue services or to government structures responsible for securing the zone.

Alternatively, according to a tenth aspect, the present invention relates to a use of the method as described hereinabove for delimiting “prohibited” zones within the scope of leisure or recreational activities, wherein the at least one exclusion zone is included, for example, in the implementation of a virtual labyrinth or a virtual role play game.

Thus, the subject matter of the present invention, through the different functional and structural aspects thereof described hereinabove, provides operators in a work environment with an approach that requires simple and easy installation and configuration of equipment, allowing the operators to be located with precision in a work environment relative to one or more exclusion zones.

### BRIEF DESCRIPTION OF THE ACCOMPANYING FIGURES

Other features and advantages of the present invention will be better understood upon reading the description hereinbelow with reference to the accompanying FIGS. 2 to 5, which illustrate one example embodiment devoid of any limiting features, wherein:

FIG. 2 diagrammatically shows the implementation of a system for making a work environment safe using at least one electronic beacon and an electronic tag carried by an operator;

FIG. 3 is a flow chart showing the steps implemented in the method for making a work environment safe using at least one electronic beacon and an electronic tag carried by an operator;

FIG. 4 diagrammatically shows the implementation of a system according to the present invention for making safe a moving worksite on a road of the motorway type with a moving danger zone; and

FIG. 5 diagrammatically shows the implementation of a system according to the present invention for making safe a very extensive work zone.

### DETAILED DESCRIPTION OF ONE ADVANTAGEOUS EXAMPLE EMBODIMENT

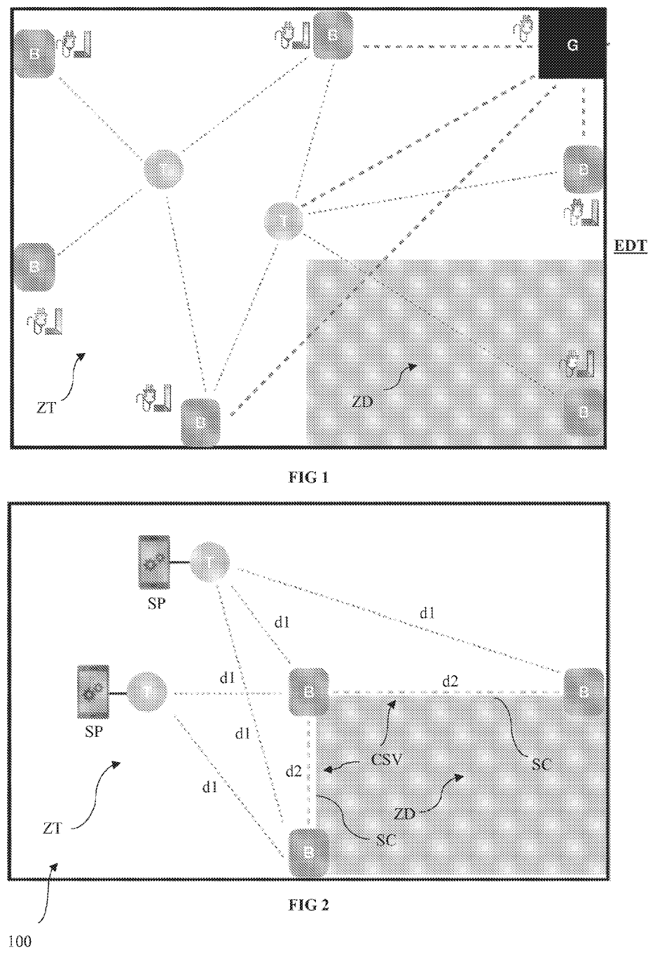

The present invention will be described hereinbelow with joint reference to FIGS. 2 to 5 accompanying the description.

Pro memoria, one of the purposes of the present invention is to propose an innovative approach for making safe a work environment ZT of the worksite type for example, comprising one or more exclusion zones ZD corresponding, for example, to a danger zone in which a hazard to the operator is present, such as, for example, an electrocution or other hazard.

In the example described here, reference is made to a situation of the type involving making safe an industrial worksite with a work environment ZT corresponding to a work zone and comprising a danger zone ZD (FIG. 2).

In this example, this more particularly involves defining, within the worksite ZT, the danger zone ZD in a substation in order to make safe the intervention of technicians during maintenance works on the worksite ZT.

It is understood here that this is a simple example among others and that the invention applies to other situations and other fields such as those listed hereinabove.

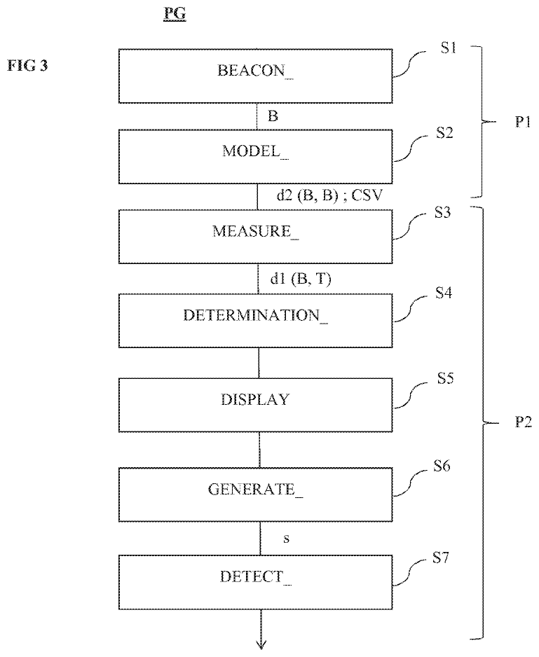

In the example described here and shown in FIGS. 2 and 3, in order to make safe such a worksite ZT, the use of a system 100 is provided, involving a plurality of electronic beacons B and a plurality of electronic tags T.

In this case, each operator moving on the worksite ZT must be equipped with a tag T and optionally with a communication terminal SP of the “Smart Phone” type for example, capable of communicating with the tag T.

One of the purposes of the present invention is to allow for the deployment of a system 100 that is easy to install, autonomous with regard to power and that does not require the use of a master device of the gateway type, the challenge in this case being to quickly and easily make potential danger zones able to communicate with the operators by way of connected objects.

To achieve this, the underlying concept of the present invention is to use the beacons B to delimit the danger zones ZD and determine a virtual safety cordon CSV that the operator must not cross.

Thus, the use of a software application is provided to configure the system 100, during an initial phase P1, and in particular to digitally model the segments SC of the virtual safety cordon CSV corresponding to the different danger zones ZD.

Thus, during this phase P1, a beaconing step S1 is provided, during which the safety manager on the worksite ZT positions a plurality of electronic beacons B on the worksite to delimit the one or more danger zones ZD of the worksite ZT.

The former thus positions the beacons B in order to virtually recreate the danger zones ZD on the worksite ZT thanks to specific computer-based means and in particular a dedicated software application installed on the communication terminal SD thereof.

More specifically, in this example, the manager positions a first beacon B on the worksite ZT at the periphery of the danger zone ZD.

Once installed, the manager powers the beacon using one of the external batteries provided. The manager then scans the beacon using the dedicated software installed on his/her communication terminal SP:
either, for example, via “NFC” by simply placing the terminal SP on this first beacon B,
or via a “QR Code” by scanning the code present on the beacon B.

After a few seconds, the software application informs the manager that the beacon B has been detected and configured.

The manager then carries out the same operations for the other beacons B.

Once all of the beacons B have been positioned on the worksite ZT, the manager confirms the creation of the danger zone ZD using the software application.

This phase P1 for configuring the worksite then includes a modelling step S2. In this example, a tag T carried by the manager is ideally connected in this step to the terminal SP thereof, for example via a wired connection (USB) or via a wireless connection (Bluetooth).

This tag T connected to the communication terminal SP is used to detect each of the beacons B installed and determine the location thereof relative to one another.

This modelling S2 carried out by computer modelling means and the dedicated software application allows the composition and the features of the segments SC of the virtual safety corridor CSV delimiting the danger zone ZD to be determined.

This is referred to as a perimetric approach.

During this step S2, the distances d2 between each of the beacons B are measured then compared to determine segments SC of the corridor between the beacons B.

This distance d2 between each beacon B corresponds to the distance between two successive beacons, in pairs, in the order in which they were configured. It is these successive beacons that allow the shortest segments SC to be determined.

Once the configuration is complete, the modelling of this corridor CSV is confirmed by the manager, then shared with the other users. This danger zone ZD is instantly transmitted to the other technicians present on the worksite ZT.

The manager continues this configuration phase P1 and repeats these different steps for all of the danger zones ZD that he/she would like to define and model by way of a virtual safety cordon CSV.

It should be noted here that, in this example, the electronic beacons B are positioned to complement an existing physical marker producing used integrated adhesive tapes.

Preferably, the beacons B are positioned at height for maximal system precision. The minimum height is preferably equal to about 50 cm.

In this example, the manager ensures that, during this phase P1, certain rules are respected, in particular the spacing between the beacons B. This is flexible and depends on the restrictions of the environment (presence of obstacles, electromagnetic fields, etc.). This spacing generally varies between five and twenty metres.

The Applicants have observed that the installation and the configuration of a beacon B within the scope of the present invention take less than a minute.

Once the beaconing operation S1 has been configured and the modelling operation S2 of all of the danger zones ZD has been completed, the staff can safely work on the worksite ZT.

This is when the so-called use phase P2 begins.

During this phase P2, each operator working on the worksite ZT connects the electronic tag T that he/she is carrying with his/her communication terminal SP; this can be carried out either via a wired connection of the USB type for example, or via a wireless connection of the “Bluetooth” type.

Preferably, the operator carries the tag T on his/her person in the most practical location possible (arm, torso, helmet, pocket, etc.).

Using the software application, the operator inputs his/her electronic tag T then starts the location service.

The operator can then put his/her terminal SP away; the operator's safety is now assured.

The tag T of the carrier more specifically procures the location thereof with respect to the danger zones ZD previously defined using the beacons B.

In the example described here, a measurement S3 of the distance d1 from the electronic tag T to each beacon B is made using measuring means.

This measurement S3 is made thanks to the establishment of communications between the beacons B and the tag T via UWB-type radio technology.

This UWB technology more specifically allows the distance between two objects to be calculated thanks to the ToF (Time of Flight): the propagation delay of a radio wave between two objects is measured to determine the distance separating them.

In the example described here, it should be noted that the tag T only seeks to calculate the distance d1 thereof from a limited number of beacons B (depending on the last position calculated and the positioning of the beacons on the site) so as to limit the number of messages exchanged and thus prevent the network from becoming congested while limiting power consumption.

In the example described here, the distance d1 between the tag T and each relevant beacon B is known.

In the example described here, the TWR (Two Way Ranging) mechanism based on the ToF is implemented to determine the distance between two objects.

This works as described below:

The tag T exchanges messages with all nearby beacons B to determine the distance thereof from each of the latter.

In this case, it is thus the tag T that carries the positioning logic. It calculates the distance information relative to the beacons B and then determines the relative position thereof on the worksite ZT.

Such an approach requires neither a master entity, nor a network connection.

Alternatively, a TDoA (Time Difference of Arrival) mechanism can be used. In this alternative, the tag transmits a single message. This message is received by the nearby beacons B and it is the time difference between when the message is received by the different beacons B that allows the position of the tag T to be determined.

In this alternative, the beacons B carry the positioning logic for the tag T. The tag T transmits a message; the beacons B receive this message and transmit it to a master entity via a network communication (generally “Wi-Fi” or Ethernet), which determines the position of the tag T. However, this alternative is less advantageous since it requires a master device for synchronising the clocks of the beacons, as well as a dedicated network over which all beacons B and the master device are connected.

It should be noted in this case that a communication scheduling solution should ideally be set up, allowing each entity to communicate in turns so that a radio communication over a given frequency is functional. More specifically, two messages cannot be exchanged at the same time.

Collisions between messages are thus avoided in the example described here by implementing a communication scheduler integrated into each of the beacons B and the tags T.

In the description below, a time slot is thus defined as a time unit required to ensure that a message is transmitted and received by the entity to which it is addressed. This slot corresponds to the maximum time required, the transmission time for a message being dependent on the size thereof. In other words, this slot is not equal to the transmission time of the message, but to the time required to ensure that this message does not collide with another message.

In this example, the communication scheduler is configured as follows:

The communication cycle of a beacon B during a phase P2 is broken down into six periods ranging from 1) to 6):
1) the beacon B is in an active waiting state for a random period of time (defined in tenths of the time slot). During this waiting period, it listens to the radio exchanges around it;
2) the beacon B transmits a message of the “BeaconStart” type indicating to the other entities around it that it is available for receiving messages;
3) the beacon listens for a determined number of time slots to the messages sent by the other entities;
4) It transmits a message of the “BeaconEnd” type indicating that it is no longer available for receiving messages and that it is going to reply to the messages received since the transmission of the “BeaconStart” message;
5) It transmits the replies linked to the messages received during the period 3); and
6) It goes to sleep for a given period of time, allowing the other beacons B the possibility of carrying out their communication cycle in turn (during this period, it can neither send nor receive any messages).

The random waiting period is defined in 1) as follows:

During the period 1), if the beacon B detects a message transmitted by another entity, it reacts accordingly:
It detects a message of the “BeaconStart” type transmitted by another beacon. In such a case, it ends its random active waiting state and awaits a message of the “BeaconEnd” type.
It detects a message of the “BeaconEnd” type transmitted by another beacon. In such a case, it resets its active waiting time (it restarts its phase 1).
It receives any other type of message. In such a case, if the active waiting time remaining is less than a communication time slot, it increments the latter by one slot.

For certain messages of the chain message type (messages to be relayed by the beacons on the network), the beacon can temporarily place itself in “tag” operating mode (refer to the operation of the tag T).

The power consumption of each beacon can be optimised.

In this example, the duration of the active listening period 3) can be dynamically adapted as a function of the number of messages received during the period 3) of the previous communication cycle by retaining a number of slots equal to the number of messages received +1.

A period of inactivity (period 6) can also be provided, which is dependent on the number of beacons B used and on the number of beacons B and of tags T within communication range. It thus dynamically adapts gradually over time between a minimum duration allowing all elements of the devices to communicate without colliding and a maximum duration ensuring that the system 100 is reactive enough to locate nearby tags. After a certain number of cycles during which no messages were received, the beacon switches to a partial standby state (maximum time of inactivity).

Finally, a filtering of the MAC type can also be provided so as not to process the messages received if they are not addressed thereto and thus reduce power consumption.

The communication cycle of a tag T is broken down into five periods ranging from 1) to 5):
1) the Tag T listens to the transmission of a “BeaconStart” type message transmitted by one of the beacons B with which it would like to communicate;
2) upon receiving a “BeaconStart” message, it randomly chooses a communication slot and sends a message to the beacon B having transmitted the message;
3) the tag T switches to an active waiting state until it receives and processes the reply from the beacon;
4) if it has to communicate with another beacon B, it returns to period 1);
5) it goes to sleep for a determined period of time (during this period, it can neither send nor receive any messages).

In the example described here, certain power consumption optimisations can also be provided as regards the operation of the tag T.

As a function of the last calculated position thereof, the period of inactivity is dynamically updated. The greater the distance from the tag T to the closest danger zone ZD, the longer the period of inactivity.

So as to affect neither the reactivity of the system, nor the performance thereof, the maximum displacement rate of a tag T from a danger zone ZD (if associated with a moving object) is taken into account when calculating the duration of the next period of inactivity.

It should be noted that the tag T can also be switched to a standby state for an indefinite period of time through an action taken by a user.

In the example described here, MAC filtering is applied so as not to process the messages received that are not addressed thereto and thus reduce power consumption.

The determination of the measurement S3 of the distances between the tag T and each relevant beacon B is used to determine S4 the relative position of the operator in the work environment ZT as a function of the distance measured d1.

The approach proposed here more specifically focuses on locating the operators in the vicinity of the danger zones ZS only, i.e. where this is the most relevant and most important, and not on spatial location as such.

When crossing a segment SC of the virtual safety cordon CSV, the tag T of the carrier carries out an operation S6 of generating a warning signal s intended for said operator.

In this example, the signal s is transmitted to the communication terminal SP, which then generates the alert (audible and/or visual and/or vibratory alert).

It should be noted here that external connectivity is not required for the system to function correctly, however it allows crossed perimeter alerts to be transmitted “outside the worksite”.

In the nominal case, the alerts are local and transmitted via the UWB tag and beacon network. However, it should be noted that, if a network connectivity is available, the alert can be sent directly to the rescue services or to a control room for example.

The present invention provides an advantageous securing system allowing a worksite to be quickly and easily made safe, without the restrictions encountered to date. The system does not impose any specific restrictions as regards the installation of the beacons: any need for prior site inspection or a specific configuration is thus avoided (the system does not need to comply with strict installation and calibration rules).

The system transmits alerts in all situations:
intentional crossing or as the result of a confused user;
deterioration of the beaconing system or system failure (beacon or tag); and
crossing or fall of a third party (shared alert).

The system set up is also resilient, i.e. it is capable of performing continuous self-diagnostics to detect the displacement or failure of any beacon B and transmit, where appropriate, the information to the operators.

Since the beaconing is able to communicate; it can thus, in an active manner, inform all operators, even in cases of confusion.

During the phase P2, it should be noted that an operation S5 can be provided to display the digital model of the work environment ZT, the beaconing of the danger zone ZS and the relative position of the operator.

This display can also take into account the global position information from a GPS or other device in the communication terminal.

It should also be noted that the tag T can be equipped with additional sensors of the accelerometer type for example, to detect, during a step S7, any fall and/or accident when an operator crosses the virtual safety cordon CSV and enters said exclusion zone ZD.

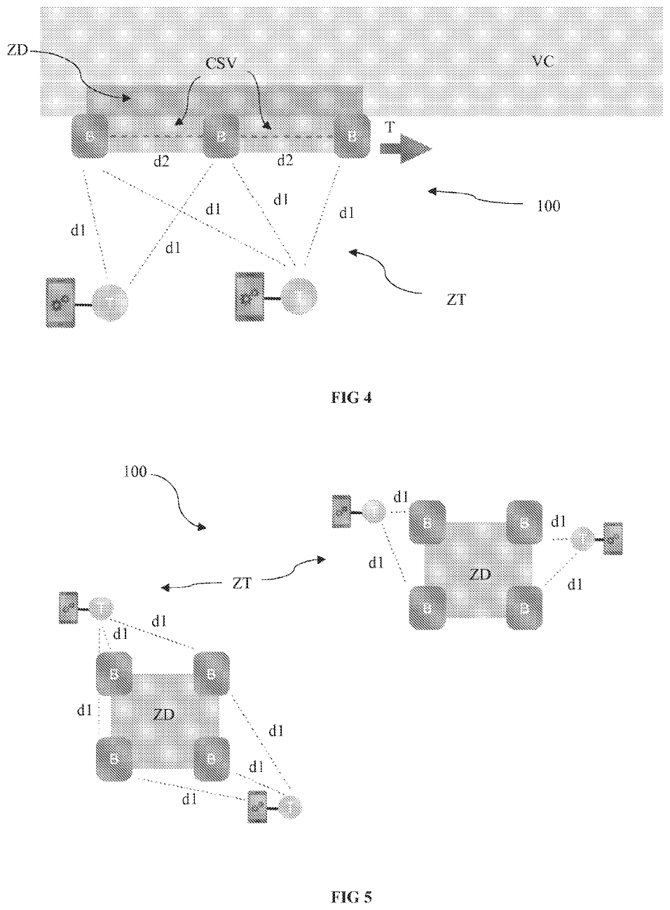

The implementation example shown in FIG. 4 shows the use of a system 100 according to the present invention for making safe a moving worksite ZT such as a worksite on a road VC of the motorway type (for example pruning, road repairs, lighting system maintenance or even road painting works, etc.).

With conventional approaches (volumetric approaches), the displacement of the danger zone inevitably involves the displacement of the beacons and that of the gateway. This displacement of the danger zone also involves a reconfiguration and/or recalibration thereof to redefine the new danger zone.

It is understood here that this operating mode is highly restrictive and prevents the solution from being a real option in such an application since the installation, configuration, power supply and network connectivity restrictions are very high.

This is especially so, since for this type of worksite, displacements are frequent and the danger zone can extend over long distances.

With the perimetric approach proposed within the scope of the present invention, the danger zone ZD can be translated T by a simple translational displacement of the beacons B along the road VC.

According to this approach, for a moving worksite, there is no longer any need to reconfigure the gateway and repeat the entire installation process.

Similarly, worksites spanning a large area can be made safe.

With the techniques known to date, according to the volumetric approach, a very high number of beacons and of gateways around the work zone and each danger zone needed to be configured.

The volumetric approach was thus highly restrictive for worksites spanning a large area. More specifically, as explained hereinabove, the restrictions regarding the installation, configuration, power supply and network connectivity are very high.

With the perimetric approach proposed within the scope of the present invention, and as shown in FIG. 5, a plurality of danger zones ZD within a vast work zone ZT spanning several kilometres in length can be easily configured. More specifically, the perimetric approach procures a simple and fast installation with optimal operation.

It should be noted that this detailed description concerns one specific example embodiment of the present invention, however in no way does this description limit the subject matter of the invention in any way: on the contrary, it aims to remove all possible imprecisions or all incorrect interpretations of the claims provided hereafter.

It should also be noted that the reference signs placed in brackets in the claims provided hereafter are in no way limiting; the sole purpose of these signs is to improve the intelligibility and understanding of the claims provided hereafter, in addition to the desired scope of protection.

1. A method for making a work environment safe using at least one electronic beacon and an electronic tag carried by an operator, said beacon and said tag being capable of communicating with one another using a communication scheduler implementing a communication management algorithm,
wherein said work environment comprises at least one exclusion zone for said operator,
said method, implemented by computer-based means and said communication scheduler, includes:
a) an initial configuration phase comprising the following steps:
beaconing in which said at least one electronic beacon is positioned in the work environment so as to delimit said exclusion zone; and
modelling the exclusion zone by generating a virtual safety cordon according to the positioning of said at least one beacon in the work environment,
b) followed by a subsequent use phase comprising the following steps:
measuring the distance of the electronic tag relative to said at least one beacon;
determining the relative position of said operator in the work environment according to the measured distance; and
generating, via said tag, a warning signal for said operator when said operator crosses said virtual safety cordon.

2. The method according to claim 1, wherein the beaconing step comprises positioning a single electronic beacon to delimit the exclusion zone in order to generate, during the modelling step, a virtual safety cordon in the form of a virtual circle, the radius whereof corresponds to a determined safety distance around said beacon.

3. The method according to claim 1, wherein the beaconing step comprises positioning at least two beacons at the periphery of said at least one exclusion zone in order to generate, during the modelling step, a virtual safety cordon in the form of a corridor comprising at least one segment defined by said at least two beacons.

4. The method according to claim 1, wherein, during the measuring step, the distance between said electronic tag and each beacon is measured.

5. The method according to claim 1, wherein the at least one beacon and said tag are capable of communicating with one another according to a communication protocol of the UWB type configured so as to determine the distance between the tag and said at least one beacon.

6. The method according to claim 1, wherein, during the modelling step, the distances of the successive beacons, in pairs, are measured in the order in which they were configured so as to determine segments.

7. The method according to claim 3, wherein said at least two beacons are capable of communicating with one another according to a communication protocol of the UWB type configured so as to determine the distances between said at least two beacons.

8. The method according to claim 3, wherein the relative position of said operator in the work environment is determined as a function of the distances from said tag to the closest segments of said exclusion zone.

9. The method according to claim 1, wherein said operator is provided with a communication terminal implementing software functions configured so as to receive said warning signal and inform said operator by way of an audible, vibratory and/or light signal.

10. The method according to claim 1, wherein said operator is provided with a communication terminal implementing software functions configured so as to provide global position information for said operator in the work environment and display, during a display step, the digital model of said work environment with the position of said operator as a function of the global position information and the relative position of said operator determined during the determination step.

11. The method according to claim 1, wherein the electronic tag (T) is provided with at least one additional sensor of the accelerometer type for example, capable of detecting, during a step a fall and/or potential accident for example when said operator crosses the virtual safety cordon and penetrates said exclusion zone.

12. The method according to claim 11, wherein each operator is provided with a tag and is warned by an audible, vibratory and/or light signal when entering an exclusion zone, in the case of a fall and/or in the case of a possible accident suffered by one of said operators.

13. The method according to claim 1, which method comprises, during the use phase continuous self-diagnostics so as to detect the displacement and/or failure of at least one beacon and alert at least one operator thereof.

14. The method according to claim 1, wherein the relative position of said operator in the work environment is determined according to a period determined dynamically as a function of the distance measured between the last position of said operator and the virtual safety cordon.

15. The method according to claim 14, wherein the greater the distance measured between the last position of said operator and the virtual safety cordon, the longer the period for carrying out the next determination step.

16. The method according to claim 1, wherein the generation of said warning signal is carried out as a function of the determined authorisation level associated with the operator carrying said electronic tag, said authorisation level being previously recorded in storage means of said tag.

17. A computer program comprising instructions suitable for executing the steps of the method according to claim 1, when said program is executed by at least one processor.

18. A non-transitory computer-readable recording medium on which a computer program is recorded, said computer program comprising instructions for executing the steps of the method according to claim 1.

19. A computer system for making a work environment safe using at least one electronic beacon and an electronic tag carried by an operator, said at least one beacon and said tag being capable of communicating with one another using a communication scheduler implementing a communication management algorithm,
wherein said work environment comprises at least one exclusion zone for said operator,
said system including:
at least one electronic beacon positioned in the work environment so as to delimit said exclusion zone; and
computer modelling means configured to digitally model the exclusion zone by generating a virtual safety cordon according to the positioning of said at least one beacon in the work environment,
measuring means configured to measure the distance from the electronic tag to said at least one beacon;
computer processing means configured to determine the relative position of said operator in the work environment according to the measured distance; and
generating means integrated into said tag, for generating a warning signal for said operator when said operator crosses said virtual safety cordon.

20. (canceled)
